(19) United States
(12) Patent Application Publication
(10) Pub. No.: US 2020/0302508 A1
(43) Pub. Date: Sep. 24, 2020

(54) CUSTOMER-CONTENT MATCHING AND VICARIOUS FEEDBACK FOR FASHION COMMERCE

(71) Applicant: Caliyan Inc., Belleville (CA)

(72) Inventors: Pallavi Hukerikar, Seattle, WA (US); Liam Jonathon Kelly, Scottsdale, AZ (US); Pia Jose Medina Llarena, Toronto (CA); Stephen Quinn Turner, Kitchener (CA)

(21) Appl. No.: 16/826,360

(22) Filed: Mar. 23, 2020

Related U.S. Application Data
(60) Provisional application No. 62/821,841, filed on Mar. 21, 2019.

(51) Int. Cl. G06Q 30/06; G06F 16/955; G06F 16/9535; A45D 44/00; H04N 21/44

(52) U.S. Cl. CPC G06Q 30/0631; G06Q 30/0643; G06Q 30/0633; H04N 21/44; G06F 16/9535; A45D 44/005; G06F 16/9558

(57) ABSTRACT

Customers shop for clothing items online for convenience and selection, to save time or because they dislike trying on such clothing items. However, such online customers often struggle to find clothing items that are right for them. How a clothing item looks, fits, and feels are all important factors when making a purchasing decision, but images of clothing items and reviews can be misleading, sizing is guesswork, reviews are hit or miss, and online customers cannot physically interact with clothing items at the online point of sale. Given this uncertainty, customers often make poor buying decisions. Returns of clothing items due to poor fit and product misunderstandings frustrate customers and cost the fashion industry billions of dollars each year. This disclosure describes an online web application, preferably used in connection with mobile devices, that aims to reduce returns and improve customer experience by combining the convenience of online shopping with information gained through physical try-ons. A customer views demonstration videos (or demonstration live-streams) of the clothing item hosted by a person (i.e., a “host”) with body measurements similar to those of the customer. As the host tries on and discusses the clothing item, the customer vicariously obtains the information necessary or desirable to make informed purchasing decisions.

### CROSS-REFERENCE TO RELATED APPLICATIONS

This Application claims priority to U.S. Provisional Application No. 62/821,841, filed Mar. 21, 2019, and entitled “Video Streaming for Fashion Commerce,” which is incorporated herein by reference in its entirety.

### FIELD OF THE INVENTION

The invention is generally related to assisting a customer with making a decision to purchase a clothing item (apparel, footwear, etc.), and more particularly, to a system and method for matching a customer to a video stream (and/or other content) curated by a host demonstrating the clothing item, where each such host has body measurements similar to those of the customer.

### BACKGROUND OF THE INVENTION

Sizes of clothing may be detrimental to a clothing retailer and its customers because sizes are not standardized. “Clothing returns have remained a major cost center for brands and [clothing] retailers. In 2015, $62.4 billion worth of global apparel and footwear purchases were returned due to incorrect sizing. [Sixty-four percent (64%) of customers] blame fit as a major reason for returning clothes, 85% would purchase more if fit was not an issue, and 46% of shoppers ‘hate’ trying on clothing.” Body Labs' 2016 Apparel & Footwear Retail Survey Report, Body Labs, formerly available at: https://www.bodylabs.com/resources/white-papers/2016-apparel-footwear-retail-survey-report/. [Accessed: 03-May-2017]. Return rates typically fall between 20 and 40 percent, and online purchases are more likely to be returned than in-store purchases. Given that online sales account for a growing percentage of clothing revenues each year, addressing the ambiguity in online shopping regarding fit and feel would save the clothing retailers approximately $94 billion in 2019 and alleviate a significant customer pain.

Although standardizing sizes would seem to be the easiest and best solution, historical attempts have failed. In 1958, the National Institute of Standards and Technology produced a set of standard sizes for American women. These efforts were undermined in the 1980s, however, when the fashion industry began to employ vanity sizing as a marketing tool. For example, a woman with a 32-inch bust may have worn a “Size 14” in a popular 1937 catalogue; by 1967, she may have worn a “Size 8;” today, she might wear a “Size 0.” The inconsistencies that customers experience today stem from the fact that brands changed their sizes at different rates and to different extents. FIG. 1 demonstrates clear differences between body types 110A, 110B, 110C of customers deemed to share the “same size.” FIG. 2 illustrates differences in key measurements, namely bust measurements 210, waist measurement 220, and hip measurements 230, across a sample of modern brands.

Consumers know that sizes vary, but they feel responsible when they struggle to find clothing that fits well. Mary Alderete, Chief Marketing Officer at The Gap, Inc., once said, “When we try on 10 pairs of jeans to buy one, the reason you feel bad is because you think something's wrong with you.” While some advocate for universal sizing, opponents argue that the premise of a “standard” body is flawed and that sizes will never effectively capture the diversity of the human body.

Despite their flaws, sizes are ubiquitous because tailoring is expensive and mass customization has not matured to the point where it can provide a viable alternative. Coping with sizes is easier when one understands how apparel products are made. “Typically, an apparel company arrives at a sizing system for a product line as follows. First, it defines a target market and typical customers by identifying demographic characteristics, such as age, income, ethnicity, and lifestyle. Then the firm chooses a single person—the ‘fit model’—to be the idealized body shape for that product and market. Prototype garments are created, then evaluated and modified in fitting sessions on the single fit model. A base size pattern, often size 8 for women, is perfected for this prototype garment, and proportional grade rules are used to scale a set of patterns up and down for the rest of the size range, e.g. 2-16. Proportional grade rules do not address the differences in the basic shapes and body proportions of the population, such as small or large waist, short or long torso, or the differences across ages and target markets. A single fit model has a particular body shape that is translated to the full range of sizes. Providing a good fit using a finite set of sizes for an almost infinite range of body types is a challenging task.” Explore Cornell—The 3D Body Scanner—Ready-to-Wear, Explore Cornell—The 3D Body Scanner—Ready-to-Wear, formerly available at: http://www.bodyscan.human.cornell.edu/scene7354.html. [Accessed: 03-May-2017]. Customers are not presented with information regarding fit models at the point of sale, so finding products that fit often requires a lot of wasteful trial and error.

Even when a customer finds a product that works for them, the fit problem may persist. According to a former supply chain employee of The Gap, Inc., garments labelled with the same size by the same brand are subject to variation because:
1. Factories do not always produce garments according to the specifications that brands provide them due to errors or imprecision in the manufacturing process. The resulting variations may necessitate sizing a batch up or down to better reflect what the brand intends a given size to be.
2. Large brands source their clothes from many different design houses or merchants. Standardizing size and fit effectively across these complicated supply chains is impossible under current industry standards.
3. When a merchant offers a garment prototype to a brand, the brand may demand a higher profit margin. To accommodate this requirement, the merchant will offer to produce the garment using cheaper materials, and the parties agree to purchase and produce it. Sometimes, the different materials cause a larger difference than the merchant expected or the brand was led to believe, leaving the brand with a large number of differently- or ill-fitting garments.

From a customer's perspective, these variations can be frustrating. In physical stores, variations cause customers to try on multiple sizes of the same product, which is inefficient and prolongs shopping sessions. Ruth Hartman, former Chief Merchandising Officer at Le Tote, relates: “I always try on four pairs of a size-8 jean in the same brand because they all fit differently.” Clothing Sizes: How Vanity Sizing Made Shopping Impossible, Time, available at: http://time.com/how-to-fix-vanity-sizing/. [Accessed: 20-Dec-2018]. In online shopping, variations erode trust—even if a customer is able to navigate sizing charts and customer reviews successfully and purchase a product that fits them well, there is no guarantee that another product of the same size and brand will also fit well. If customers tire of researching every product they purchase, uncertainty forces them to take a leap of faith that often results in a product return.

The typical apparel shopping process involves customers selecting a brand (or retailer of brands) they want to purchase from, the clothing item they want to purchase, and what they hope is the right size for that clothing item and brand. We will refer to this process as the “Brand→Item→Size Paradigm.” The problem with this sequence is that, unbeknownst to the customer, none of the brand's fit models or scaled sizes may match the customer, and therefore none of the clothing items the customer will consider may fit the customer well. This suggests that information regarding the fit model for a given clothing item may be of great utility to the customer when making a buying decision, but no such information is readily available, let alone at the point of sale. Even if information regarding the fit model were available, there is no guarantee that the customer would understand their body well enough to make useful comparisons.

In some cases, brands might provide a large number of product measurements to help the customer make an informed purchasing decision with respect to fit, but that would likely complicate the shopping process to the detriment of sales. As a result, references such as online sizing charts only contain a few core measurements. For example, the sizing chart for a t-shirt may include chest and waist measurements but may not include details such as the breadth of the shoulders or the circumference of the sleeves, which impact the quality of the fit and style. Given limited and imperfect information and no effective coping mechanisms, it is no surprise that customers often purchase clothing item(s) that do not fit well.

Furthermore, in countries like the United States and Canada, where obesity rates are 36.2% and 29.4%, respectively (World Health Organization, 2017), a “sizing stigma” associated with plus sizes for women and, to a lesser degree, plus and small sizes for men, seriously affects the mental state of many consumers. “[Sixty-seven percent] of American women wear a size 14 or above . . . And yet, the plus-size market is treated as an afterthought. Nearly all advertising campaigns feature thin models. Most designers refuse to make plus-sized clothing . . . For shoppers, the message is inescapable: if you're over a certain size, you don't belong.” Clothing Sizes: How Vanity Sizing Made Shopping Impossible, Time. The negative results of this sizing stigma on public well-being are recognized by many fashion, physical, and mental health professionals.

In addition, “The way we design, produce, and use clothes has drawbacks that are becoming increasingly clear. The textiles system operates in an almost completely linear way: large amounts of non-renewable resources are extracted to produce clothes that are often used for only a short time, after which the materials are mostly sent to landfill or incinerated . . . total greenhouse gas emissions from textiles production, at 1.2 billion tonnes annually, are more than those of all international flights and maritime shipping combined.” A New Textiles Economy: Redesigning Fashion's Future, Ellen MacArthur Foundation, available at: http://www.ellenmacarthurfoundation.org/publications, 2017. Returns aggravate these issues because they require additional shipping and handling and are often discarded. Now consider that the industry average sell-through rate is about 60% (K. Miller, Fashion's New Fast Lane, Forbes, 19-Jun-2013, available at: https://www.forbes.com/2006/09/13/leadership-fashion-retail-lead-innovation-cx_ag_0913fashion.html#3bee6c59c456. [Accessed: 14-Dec-2018]), and that brands often destroy unsold inventory, or “dead stock.” “Burberry's [2018] annual report revealed £28.6 million ($38 million) worth of stock was sent to be incinerated last year . . . The practice of destroying unsold stock, and even rolls of unused fabric, is commonplace for luxury labels. Becoming too widely available at a cheaper price through discount stores discourages full-price sales and sending products for recycling leaves them vulnerable to being stolen and sold on the black market” O. Pinnock, No One In Fashion Is Surprised Burberry Burnt £28 Million Of Stock, Forbes, 26-Jul-2018, available at: https://www.forbes.com/sites/oliviapinnock/2018/07/20/no-one-in-fashion-is-surprised-burberry-burnt-28-million-of-stock/#165ab35c4793. [Accessed: 22-Oct-2018].

No current solution adequately addresses the fit problem, let alone the combination of the fit problem, Brand→Item→Size Paradigm, stigma, and environmental impact of the fashion industry.

### SUMMARY OF THE INVENTION

Various implementations of the invention are directed toward solutions to the problems identified above. To address the fit problem, various implementations of the invention provide an online shopping environment that improves a way by which a customer finds a clothing item (including, but not limited to an apparel clothing item, a footwear clothing item, an accessory clothing item, a beauty item, or other clothing item) that fits or suits the customer well without relying entirely on sizes and without requiring the customer to go to a physical “bricks-and-mortar” store in order to physically interact with the clothing item to determine fit, feel, and suitability.

To address issues associated with the Brand→Item→Size Paradigm, various implementations of the invention may make “fit” a priority, with the customer making a final purchasing decision from a subset of clothing items that are each likely to fit the customer well.

To combat sizing stigma, various implementations of the invention downplay an importance of size labels associated with the clothing item and reveal to the consumer that there is a community of people with bodies similar to their own, thereby alleviating any anxiety the consumer may feel when shopping for clothing items.

Various implementations of the invention may incorporate influencer marketing, curation, video, and mobile commerce platforms to support those who curate products for others in order to help the customer make informed purchasing decisions, in some cases on mobile devices using a video format.

Various implementations of the invention may reduce clothing item return rates and any attendant greenhouse gas emissions. To further mitigate any environmental impact of the fashion industry, various implementations of the invention may increase sell-through or otherwise incorporate dead stock, thereby increasing supply chain efficiency and brand profitability.

In various implementations of the invention, the customer may save time and effort in identifying and trying on clothing items by having the hosts curate the clothing items on behalf of the customer.

In various implementations of the invention, the customers view video streams of the clothing items curated by hosts with similar body measurements to their own. As hosts try on, discuss and interact with clothing items, customers vicariously obtain the information customers need to make confident purchasing decisions. In some implementations of the invention, hosts provide customers at least one highly-relevant, contextually rich, high-quality review of the clothing item to help customers understand which clothing item (and size) is right for them. In some implementations of the invention, the customers view still images (or other media) of the clothing item, in addition to or in lieu of, the video streams, curated by hosts with similar body measurements to their own. Such still images may depict the host wearing the clothing item and may be accompanied by information to assist the customer in making purchasing decisions.

In various implementations of the invention, customers may view video streams for purposes of entertainment or for purposes of staying aware of various brands' product offerings.

In various implementations of the invention, mimetic desires of the customer may be supported by displaying, in some implementations in real-time, a number of customers who have purchased a clothing item (or added the clothing item to their shopping carts). In some implementations of the invention, some customers may desire rare clothing items, which may be supported by displaying a number of remaining clothing items during a limited product offering, incentivizing customers who value exclusivity to purchase quickly.

In various implementations of the invention, customer body measurements may be incorporated into a shopping transaction, thereby improving customer experience by: 1) allowing the customer to see what the clothing item looks like on a host having body measurements similar to their own, and 2) simplifying or expediting a transaction checkout process by automatically recommending or ordering the size most likely to fit the customer based on the size appropriate for the host. Some implementations may reduce return rates because customers are guided by the hosts to clothing items that should fit the customer well. In some implementations of the invention, vicarious feedback reduces return rates by clearing up misunderstandings the customer may have regarding the clothing item (e.g., materials, colors, etc.) before the purchasing decision.

In some implementations of the invention, prizes may be offered to customers to increase viewership of clothing items associated with a given brand, host, channel, etc. These prizes may be sourced from dead stock and thus, reduce financial and environmental burden of such inventory. In some implementations of the invention, prizes may be offered in connection with trivia-style questions to gamify the experience and cause viewers to pay close attention. Correct answers may be rewarded with credits that can be used to skip other advertisements, applied at checkout, or increase the chances of receiving a prize.

Various implementations of the invention provide information customers need or desire to make confident purchase decisions, particularly online purchase decisions. Such implementations increase the likelihood that purchased clothing items will fit well. Vicarious feedback through hosts increases the likelihood that the clothing items will match expectations of the customers. When customers are confident that they understand a clothing item they wish to purchase (i.e., how the clothing item looks, fits, feels, etc.), the customers are less likely to purchase multiple sizes of the clothing item with the intent to return those that don't fit. For similar reasons, customers are also less likely to return clothing items because of color, fit, and material misunderstandings than they would be on other online shopping platforms. Further, for first-time customers, increasing the likelihood that their first purchase will fit them well significantly increases the likelihood that they will become repeat customers.

Various implementations of the invention support brand development by allowing brands to explore creativity and control brand image and narrative more than on any other online platforms. Some implementations may incorporate brands' promotional content into or alongside video streams. Such promotional content may include hosting discussions with the designers of a new collection or showcasing new environmental initiatives associated with certain offerings.

In some implementations of the invention, the customer is provided with a direct purchasing option (e.g., a shopping cart, etc.) for purchasing the clothing item as would be appreciated. In some implementations of the invention, the customer is provided with an indirect purchasing option (e.g., a link to a site where the clothing item is offered) for purchasing the clothing item as would be appreciated. For purposes of this description, purchase includes buy, rent, lease, or subscribe as would be appreciated.

Various implementations of the invention may prompt the customer to provide feedback regarding how the purchased clothing item fits or otherwise meets their expectations. Responses from the customers may be compared with sizing guides, user body measurements, and/or other information to determine (and/or refine) fit preferences and inform the design of future products.

### BRIEF DESCRIPTION OF THE DRAWINGS

FIG. 1 illustrates different body types deemed to share a same size.

FIG. 2 illustrates differences in key measurements across a sample of modern brands.

FIG. 3A illustrates a set of hosts and a set of clothing items available for purchase in accordance with various implementations of the invention.

FIG. 3B illustrates individual hosts each curating a clothing item made available as a video stream in accordance with various implementations of the invention.

FIG. 3C illustrates a set of customers each interacting with a respective video stream on a mobile device in accordance with various implementations of the invention.

FIG. 4 illustrates comparing customer body measurements of a customer, host body measurements of a host, and sizing guides for a clothing item to determine a match between the customer and the host for that clothing item, and subsequently provide content about the clothing item to the customer in accordance with various implementations of the invention.

FIG. 5 illustrates clusters of hosts and customers for Brand A according to various implementations of the invention.

FIG. 6 illustrates clusters of hosts and customers for Brand B according to various implementations of the invention.

FIG. 7 illustrates clusters of hosts and customers for Brand A, in further detail, according to various implementations of the invention.

FIG. 8 illustrates clusters of hosts and customers for Brand B, in further detail, according to various implementations of the invention.

FIG. 9 illustrates a system according to various implementations of the invention.

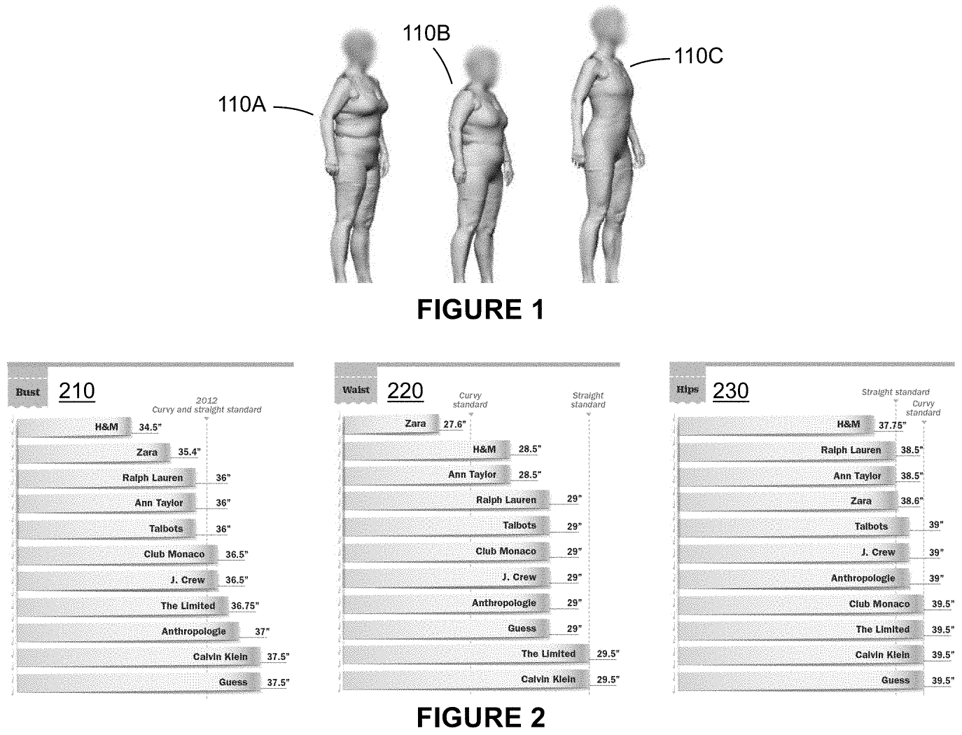

### DETAILED DESCRIPTION

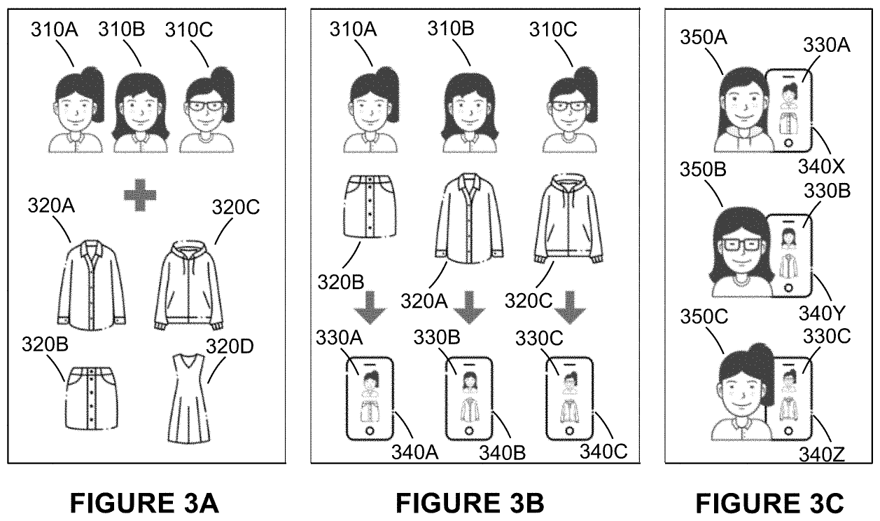

Various implementations of the invention assist a customer with a buying decision with regard to a clothing item by addressing ambiguity in online shopping regarding look, fit, and feel of the clothing item. FIG. 3A illustrates a set of hosts (collectively hosts 310, and individually as a host 310A, a host 310B, and a host 310C) and a set of clothing items (collectively clothing items 320, and individually as a clothing item 320A, a clothing item 320B, a clothing item 320C, and a clothing item 320D), where clothing items 320 are available for purchase in accordance with various implementations of the invention. In some implementations of the invention, at least one host in the set of hosts 310 has similar body measurements to those of the customer.

FIG. 3B illustrates each individual host 310 curating (i.e., collecting, selecting, presenting, demonstrating, reviewing, evaluating, or otherwise providing information or content, including, but not limited to, pictures, video, description, specifications, etc.) one or more of clothing items 320 via a video stream 330 accessible on, for example, a mobile device 340, where a particular clothing item 320 that fits host 310 well and/or that host 310 recommends, or where the particular clothing item 320 is likely to be appreciated (and subsequently purchased) by customers served by host 310 (e.g., so called “host communities”) based on viewing, reaction, and purchase histories of such customers in such host communities. For example as illustrated in FIG. 3B, host 310A curates clothing item 320B by appearing in a video stream 330A accessible via a mobile device 340A; host 310B curates clothing item 320A by appearing in a video stream 330B accessible via a mobile device 340B; and host 310C curates clothing item 320C by appearing in a video stream 330C accessible to the customer via a mobile device 340C. In some implementations of the invention, video stream 330 depicts host 310 modeling, wearing, demonstrating or otherwise interacting with clothing item 320. In some implementations of the invention, video stream 330 depicts host 310 discussing clothing item 320 in terms of its look, feel, movement, flexibility, etc. In some implementations of the invention, video stream 330 depicts host 310 wearing a size of clothing item 320 preferred or recommended by host 310; In some implementations of the invention, video stream 330 depicts host 310 wearing a size of clothing item 320 larger than the size preferred or recommended by host 310, for example, to assist customers who prefer a looser fit; and/or In some implementations of the invention, video stream 330 depicts host 310 wearing a size of clothing item 320 smaller than the size preferred or recommended by host 310, for example, to assist customers who prefer a tighter fit. According to various implementations of the invention, hosts 310 provide guidance to the customer via video streams 330 in order to assist the customer in making confident purchase decisions.

FIG. 3C illustrates a set of customers 350, each customer 350 interacting with a respective video stream 330 on its mobile device 340. For example, a customer 350A interacts with video stream 330A on a mobile device 340X; a customer 350B interacts with video stream 330B on a mobile device 340Y; and a customer 350C interacts with video stream 330C on a mobile device 340Z.

For purposes of this description, clothing item 320 includes, but is not limited to: an apparel clothing item (sometimes “apparel”), a footwear clothing item (sometimes “footwear” or “shoe”), an accessory clothing item (sometimes “accessory”), or other clothing item. Further, various aspects of the invention may apply to other items not strictly characterized as “clothing,” such as, but not limited to, beauty items (e.g., scents, perfumes, foundation, blush, lip care, anti-aging creams, astringents, creams, mascara, eyeshadow primer, facial cleansing products, tools such as eyelash curlers, or other beauty items); in which case, relevant factors regarding such item (in this example, eye color, hair color, skin tone, skin color, skin complexion, skin condition (dry/oily), etc.) are shared between customer 350 and host 310.

According to various implementations of the invention, customers 350 may be matched to content (generally), including video streams 330 via various matching techniques including, but not limited to, 1) customer-host matching with styles; 2) customer-host-product matching using comparators; and/or 3) customer-host-product matching using, for example, k-means clustering. Each of these matching techniques is described below; however, other matching techniques may be used without departing from the scope of the invention as would be appreciated.

In the so-called “customer-host matching with styles” matching technique, customers 350 are matched to content, including, but not limited to, video streams 330, based on customer body measurements, host body measurements, and product style. In such implementations, customers 350 and hosts 310 are matched to one another based on body measurements (and matches are updated as new body measurements are recorded). In some implementations of the invention, customers 350 may also specify clothing items 320, or styles thereof, in which they are interested. When a host 310 creates a video stream 330 (or other content) associated with such clothing item 320 of interest, customers 350 within the host community of host 310 may be notified.

In some implementations of the invention, a style filter may be employed to personalize content, including video streams 330, presented to customer 350. Such style filters may be established based on feedback gathered over time from customer 350, including, but not limited to viewing, reaction, and purchase histories from a given customer 350 or host community. Such style filters may also be established based on explicit feedback from customer 350, for example, by providing customer 350 with a set of styles and example products that fit those styles and having customer 350 select styles in which they are interested.

In some implementations of the invention, hosts 310 provide vicarious feedback to customers 350 by serving as a visual reference via video streams 330 for clothing item 320 and answering various questions customers 350 may have when making purchasing decisions. Such questions may fall into various categories including, but are not limited to 1) Personal Opinion; 2) Form, Fit, Feel, and Function; 3) Price, Quality, and Value; 4) Variants (e.g. Colors, Tall/Petite, etc.); 5) Complementary and Supplementary Products; 6) Care Instructions; and 7) Conscientious Consumption. Some questions (and their associated answers) may be implicit in the sense that customers 350 may get a sense of form and fit by seeing products on host 310; and some questions may also be explicitly answered elsewhere (e.g., price, variants, etc.).

For apparel clothing items, the Personal Opinion category of questions may include, but is not limited to: a) Does the host like the clothing item?; b) Does the host like the brand of the clothing item?; c) Does the host feel good about their self when they wear the clothing item?; and/or d) What does the host like about the clothing item, what doesn't the host like and/or what would the host change (if anything)?. For apparel clothing items, the Form, Fit, Feel and Function category of questions may include, but is not limited to: a) How does the clothing item feel? Is the clothing item comfortable? Is the clothing item itchy/soft/stretchy/warm/cold/breathable?; b) How does the clothing item fit? Where does the waist fall? Does the seam hit the shoulder properly? Does the clothing item cling or gape anywhere?; c) What is the clothing item made of? What are the fabrics/materials? Are they organic/free of harsh chemicals?; d) What happens when the host moves around? Does the clothing item move freely or stiffly with the host's body? What happens when the host lifts their arms up or bends forward/down? Is the clothing item still comfortable sitting down (e.g. do the pants grab awkwardly or pull down, does the waist seem uncomfortably tight, etc.)?; and/or e) Was the clothing item made for a specific purpose (e.g. evening wear, being outdoors, etc.)?. For apparel clothing items, the Price, Quality, and Value category of questions may include, but is not limited to: a) How much is the clothing item?; and/or b) Is the clothing item well-made/of good quality?. For apparel clothing items, the Variants category of questions may include, but is not limited to: a) Does the color of the clothing item look like it does in the photos?; b) Does the clothing item come in other colors?; and/or c) Is the clothing item depicted a tall/petite variant or does the clothing item come in a tall/petite variant? For apparel clothing items, the Complementary and Supplementary Products category of questions may include, but is not limited to: Does the clothing item require a camisole/belt? For apparel clothing items, the Care Instructions category of questions may include, but is not limited to: How does the customer clean the clothing item (e.g. machine wash cold with like colors, dry clean, etc.)? For apparel clothing items, the Conscientious Consumption category of questions may include, but is not limited to: a) Does the brand produce clothing items in an environmentally-conscious manner?; b) Is the production process free of harsh chemicals?; c) Are materials natural and sourced ethically (e.g. free-trade, fair-trade)?; and/or d) What are employee working conditions?

For footwear clothing items, the Personal Opinion category of questions may include, but is not limited to: a) Does the host like the clothing item?; b) Does the host like the brand?; c) Does the host feel good about their self when the host wears the clothing item?; and/or d) What does the host like about the clothing item, what doesn't the host like, and what would the host change? For footwear clothing items, the Form, Fit, Feel and Function category of questions may include, but is not limited to: a) Is the clothing item comfortable?; b) Is the clothing item warm/cold/breathable/insulated/waterproof (e.g. for winter boots)?; c) Is the clothing item too tight/loose? At which particular point in the shoe?; d) How high is the heel (the heel of the shoe, rather than the heel of the body)?; e) Does the clothing item feel like it provides good arch support/does it actually provide good arch support?; f) Does the clothing item pinch the host's toes?; g) Does the clothing item rub or ride up and down the host's heel (the heel of the body, rather than the heel of the shoe)/ankle?; g) Does the clothing item start hurting if the host walks around in it for a while?; h) What are the uppers made of?; i) What are the soles made of (e.g. some men prefer leather soles for their formal shoes)?; j) Do the materials seem like they would get dirty quickly (e.g. white soles)?; k) Will the material stretch out or relax over time?; and/or l) Was the clothing item made for a specific purpose (e.g. running, hiking, etc.)? For footwear clothing items, the Price, Quality and Value category of questions may include, but is not limited to: a) How much is the clothing item?; and/or b) Is the clothing item well-made/of good quality? For footwear clothing items, the Variants category of questions may include, but is not limited to: a) Does the color of the clothing item look like it does in the photos?; and/or b) Does the clothing item come in other colors? For footwear clothing items, the Complementary and Supplementary Products category of questions may include, but is not limited to: a) What type of socks (if any) should the customer wear with the clothing item? For footwear clothing items, the Care Instructions category of questions may include, but is not limited to: a) How would the customer clean the clothing item? For footwear clothing items, the Conscientious Consumption category of questions may include, but is not limited to: a) Does the brand produce shoes in an environmentally-conscious manner?; b) Is the production process free of harsh chemicals?; c) Are materials natural and sourced ethically (e.g. free-trade, fair-trade)?; and/or d) What are employee working conditions?

For accessory clothing items, the Personal Opinion category of questions may include, but is not limited to: a) Do you like the accessory?; b) Would the host wear the accessory all the time or only on special occasions or with specific outfits?; c) Does the host like the brand?; d) Does the host feel good about their self when the host wears the accessory?; and/or d) What does the host like about the accessory, what doesn't the host like, and what would the host change?. For accessory clothing items, the Form, Fit, Feel and Function category of questions may include, but is not limited to: a) What is the accessory (some users may be unfamiliar with certain accessories)?; b) What is the accessory made of (this may be especially important for things like earrings because some people's skin reacts to certain materials and/or impurities in those materials)?; c) How does the accessory look?; d) What outfits will the accessory go well with?; d) Is the accessory heavy?; and/or e) Does the accessory have sharp edges that may catch on clothing? For accessory clothing items, the Price, Quality and Value category of questions may include, but is not limited to: a) How much is the accessory item?; and/or b) Is the accessory item well-made/of good quality, or does the accessory item look or feel cheap? For accessory clothing items, the Variants category of questions may include, but is not limited to: a) Does the color of the accessory look like it does in the photos?; and/or b) Does the accessory come in other colors? For accessory clothing items, the Complementary and Supplementary Products category of questions may include, but is not limited to: a) What other accessories would go well with this accessory (i.e. to complete an outfit/look)? For accessory clothing items, the Care Instructions category of questions may include, but is not limited to: a) How would the customer clean the clothing item? For accessory clothing items, the Conscientious Consumption category of questions may include, but is not limited to: a) Does the brand produce accessories in an environmentally-conscious manner?; b) Is the production process free of harsh chemicals?; c) Are materials natural and sourced ethically (e.g. free-trade, fair-trade)?; and/or d) What are employee working conditions?

For beauty items, the Personal Opinion category of questions may include, but is not limited to: a) Do you like the beauty item?; b) Would the host wear the beauty all the time or only on special occasions or with specific outfits?; c) Does the host like the brand?; d) Does the host feel good about their self when the host wears the beauty item?; and/or d) What does the host like about the beauty item, what doesn't the host like, and what would the host change?. For beauty items, the Form, Fit, Feel and Function category of questions may include, but is not limited to: a) Does the beauty item work well?; b) Is the beauty item easy to apply; c) Is the beauty item for everyday wear?; d) Is the beauty item oily/dry?; e) Does the beauty item blend well?; f) How does the beauty item feel on the skin (fresh, light, heavy, greasy, etc.)?; g) What is the beauty item made of (this may be especially important because some people's skin reacts to certain substances and/or impurities in those substances)?; h) Will the beauty item be OK for sensitive skin?; and/or g) Does the beauty item have a scent? If so, how strong is the scent and what do you think of it? For beauty items, the Price, Quality and Value category of questions may include, but is not limited to: a) How much is the beauty item?; b) How long will the beauty item last?; and/or c) Cost versus quality comparison—there are so many beauty products that do similar things—which product stands out from the others but doesn't cost more? For beauty items, the Variants category of questions may include, but is not limited to: a) Does the color of the beauty item look like it does in the photos?; and/or b) Does the beauty item come in other colors? For beauty items, the Complementary and Supplementary Products category of questions may include, but is not limited to: a) What other products go well with the beauty item? For beauty items, the Conscientious Consumption category of questions may include, but is not limited to: a) Does the brand produce beauty items in an environmentally-conscious manner?; and/or b) Is the beauty item free of harsh chemicals and irritants?

According to various implementations of the invention, the more similar the body measurements of customer 350 to those of host 310, the more meaningful the feedback from host 310 regarding clothing item 320, and the more comfortable customer 350 feels when making purchasing decisions based on recommendations from host 310. For example, a tall customer 350 may prefer a tall 310 host to a short host 310, because customer 350 feels that tall host 310 may provide more relevant feedback. In some implementations of the invention, to accommodate a significant variation in body types (and/or body measurements) across human population, hosts 310 are selected to reflect such variation in order to service diverse customers 350.

Various implementations of the invention may utilize various body measurements of customer 350 (e.g., “physical” body measurements) for purposes of matching customer 350 with host(s) 310. These body measurements may include, but are not limited to one or more of the following: a) Age—How old are you? People with similar weights but different ages may prefer differently-fitting garments because the distribution of weight throughout the body changes with age. Also, purchasing behavior may differ with age, allowing us to provide better product recommendations; b) Height—How tall are you? People with similar weights but different heights may prefer differently-fitting garments due to differences in weight distribution throughout the body; c) Weight—How much do you weigh? Weight provides for better product recommendations when combined with age, height, and purchasing behavior; d) Head—Measure the circumference of the head just above the ears, keeping the measuring tape horizontal. This measurement may be used, for example, for hats; e) Neck—Measure the circumference of the neck a bit above the shoulders. This measurement may be used, for example, for collars and some accessories; f) Shoulder Width—Imagine two lines going straight up from the armpits. Measure the distance between those lines. This measurement may be used for example, for tops, sweaters, coats and jackets; g) Chest (Men)/Bust (Women)—Measure around the fullest part of the chest. This measurement may be used, for example, for tops, sweaters, coats and jackets; h) Underbust (Women)—Measure around the ribcage, just under the bust. This measurement may be used, for example, for bras; i) Torso—Tilt the head forward and find the bony bit that seems to stick out (this is the seventh cervical vertebra). Place hands on the tops of the hip bones. Measure from the seventh cervical vertebra down the middle of the back to the imaginary line between the thumbs. This measurement may be used, for example, for tops and jackets; j) Sleeve Length—Place the hand on the hip. Start from the seventh cervical vertebra again and measure to the top of the shoulder, then down to the elbow, then down to the bottom of the wrist. Sometimes arms can be different lengths, so feel free to measure both sleeve lengths and average the two values if desired. The sleeve length is measured from the seventh cervical vertebra instead of the shoulder because some tops (e.g., those with drop shoulders) do not have a shoulder seam. This measurement may be used, for example, for tops, sweaters, coats and jackets; k) Upper Arm—Measure the circumference of the fullest part of the upper arm. This measurement may be used, for example, for tops, sweaters, coats and jackets; l) Wrist—Measure the circumference of the wrist. This measurement may be used, for example, for long-sleeved tops, coats and jackets. Even if sleeves are a bit long, a close-fitting wrist can produce a good fit; m) Waist—Measure the circumference of the body approximately 1-2 inches (2.5-5 cm) above the belly button or around the narrowest part of the waist. This measurement may be used, for example, for close-fitting garments; n) Hips—Measure the circumference of the body around the tops of the hip bones (probably just under the belly button). This measurement may be used, for example, for tops and bottoms; o) Seat—Measure the circumference of the fullest part of the hips and bum. This measurement may be used, for example, for bottoms; p) Thigh—Measure the circumference of the fullest part of the thigh. This measurement may be used, for example, for bottoms; q) Inseam—Measure from the lowest point between the legs to the middle of the ankle bone. This measurement may be used, for example, for pants; r) Outseam—Measure from the top of the hip bone down to the ankle. This measurement may be used, for example, for pants and some other bottoms; s) Ankle—Measure the circumference of the ankle, just above the ankle bones. This measurement may be used, for example, for pants, footwear, and some accessories; t) Foot Length—Measure the full length of the foot from the back of the heel to the front of the toes. This measurement may be used, for example, for footwear; and/or u) Foot Width—Measure the widest part of the foot. Depending on how the foot is shaped, the widest part of the foot may be different than the widest part of the foot in the picture. This measurement may be used, for example, for footwear.

In some implementations of the invention, various thresholds may be established around each customer body measurement and/or each host body measurement in order to establish an acceptable match between customer 350 and host 310, preferably resulting in an acceptable fit for customer 350 for any given clothing item—body measurement(s) beyond such threshold(s) may be indicative of an unacceptable match between customer 350 and host 310, potentially resulting in an unacceptable fit for customer 350 for that particular clothing item. In some implementations of the invention, such thresholds may be used to establish a number of hosts 310 necessary or desirable to service diverse customers 350.

In some implementations of the invention, more body measurements may be superior to fewer body measurements; however, more body measurements may dissuade customers 350 from engaging due to a lengthier initial onboarding process. In some implementations of the invention, a number of body measurements deemed to be indicative of acceptable fit may be adjusted over time based on, for example, customer feedback, number of returns, etc.

In some implementations of the invention, various body measurements may be weighted differently from one another depending upon a relevance of such body measurement to acceptable fit. For example, differences in chest/bust measurements between host 310 and customer 350 may be more important than differences in wrist measurements when the clothing item is a long-sleeved shirt. Also, for example, differences in sleeve length measurements between host 310 and customer 350 may be entirely irrelevant when the clothing item is a short-sleeved t-shirt. Assigning different weights among such body measurements may account for differences in relevance of such body measurements for acceptable fit. Various methods for determining such weighting of body measurements may include neural networks, simulated annealing algorithms or other weighting techniques as would be appreciated.

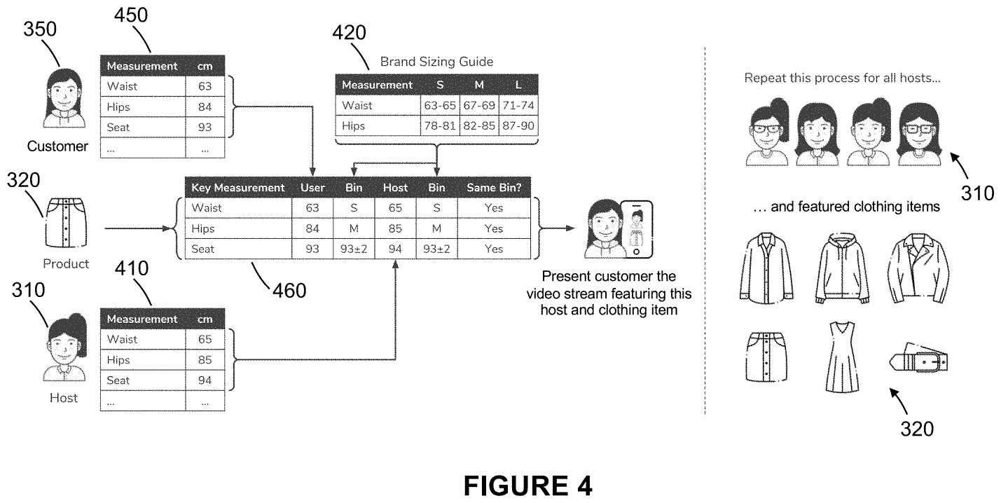

In the so-called “customer-host-product matching using comparators” matching technique, various implementations of the invention may compare customer body measurements 450 of customer 350, host body measurements 410 of host 310, sizing guides 420 for clothing item 320 (and/or any other relevant information as would be appreciated) as illustrated in FIG. 4. In some implementations of the invention, a subset of body measurements deemed “key measurements” 460 for each clothing item 320 may be determined as would be appreciated. In some implementations of the invention, these key measurements 460 may be determined by host 310 as necessary or desirable for acceptable fit. In some implementations of the invention, a size of clothing item 320 from sizing guides 420 may be determined for customer 350 based on customer body measurements 450 and for host 310 based on host body measurements 410. In some implementations of the invention, when the size of clothing item 320 for customer 350 matches the size of clothing item 320 for host 310, video stream 330 featuring such host 310 and such clothing item 320 may be provided to such customer 350. In some implementations of the invention, a matched size of clothing item 320 for customer 350 and host 310 may not be a size featured and recommended by host 310 in video stream 330; rather, host 310 will recommend a size of clothing item 320 that they deem to be most suitable for themselves and customer 350.

In some implementations of the invention, key measurements 460 may be determined by host 310 rather than obtained from sizing guides 420 to subjectively determine such key measurements 460. In some implementations of the invention, the thresholds described above may also be used as would be appreciated.

In some implementations of the invention, body measurements in addition to the key measurements may be used as desirable or necessary to further assure acceptable fit. For example, if a shirt has key measurements of chest circumference, shoulders width, and sleeve length, ensuring that an additional body measurement of waist circumference of customer 350 does not exceed the waist circumference of clothing item 320 (including any thresholds, etc.) may be desirable or necessary as would be appreciated.

In some implementations of the invention, even though host body measurements 410 and customer body measurements 450 suggest a particular size of clothing item 320, such size may only be a starting point of reference and may not ultimately be the size recommended to customer 350. For example, host 310 may try on the suggested size and determine that a size up or a size down provides a more acceptable fit of clothing item 320 for host 310, and vicariously, for customer 350. In some implementations of the invention, host 310 may actually demonstrate the suggested size, the size up and/or the size down during video stream 330 to guide customer 350 to clothing items and their sizes that will actually fit customer 350 well or in line with preferences of customer 350 (i.e., preference for loose-fitting or tight-fitting clothes). In other words, hosts 310 try on clothing items so customers don't have to. In some implementations of the invention, customers 350 may purchase a size other than that recommended by host 310, based on their personal preferences, as would be appreciated.

In some implementations of the invention, acceptable fit may be determined on a level of clothing item 320. For most clothing items, a number of key measurements is fewer than a number of measurements in a section of a physical body (e.g. upper, lower) or the body overall. For example, upper body measurements may include neck, shoulder width, sleeve length, torso length, wrist, chest, waist, and hips, but a given shirt may only have the key measurements of chest and shoulder width. In this example, the matching problem is less constrained by the clothing item (with two key measurements) than the matching problem between upper body measurements of host 310 and customer 350 (with eight upper body measurements). As a result, matching host 310 with customer 350 based on the two key measurements of clothing item 320 greatly reduces a number of hosts 310 required to service the customer base for that particular clothing item.

In some implementations of the invention, a number of hosts 310 may be selected based on a number of sizes in which a clothing item is offered. In some embodiments of the invention, greater or fewer numbers of hosts may be used depending upon clothing items 320 and size diversity among customers 350 as would be appreciated.

In some implementations of the invention, additional host body measurements 410 (which may include all available host body measurements 410) may be provided to customer 350 beyond those key measurements of clothing item 320 deemed necessary or desirable to inform customer 350 regarding sizing of clothing item 320 and/or any additional body measurements deemed important or relevant by host 310. Such additional host body measurements 410 allow customer 350 to consider whether differences between customer body measurements 450 and these additional host body measurements 410 might impact fit of clothing item 320 on customer 350 in order to further inform a purchasing decision.

In some implementations of the invention, hosts 310 may also direct attention of customer 350 to certain measurements of clothing item 320. For example, when featuring a long-sleeved shirt, host 310 might say “The sleeves are a bit long on me, so check your measurement comparison table, and if your sleeve length is a bit longer than mine, this might be a great product for you.”

In some implementations of the invention, certain brands (or manufacturers) may explicitly state which measurements they believe to be more important than others. For example, certain brands may recommend that customer 350 purchase tops according to a bust/chest measurement if the bust/chest measurement and a waist measurement map to different sizes in a sizing guide. Similarly, certain brands may recommend that customer 350 purchase bottoms according to a hip measurement if the hip measurement and a waist measurement map to different sizes in the sizing guide. In some implementations of the invention, video stream 330 (or other associated content) may provide customers 350 with such brand recommendations; and in some implementations of the invention, video stream 330 (or other associated content) may provide customers 350 with such brand recommendations in conjunction with any other recommendations from host 310.

Various implementations of the invention may utilize various machine learning techniques, including unsupervised learning techniques, in order to match customers 350, hosts 310 and clothing items 320. One such unsupervised learning technique may be a “K-means clustering” technique which is described herein relative to various implementations of the invention. However, other machine learning techniques may be used as would be appreciated.

With K-means clustering techniques (which are generally understood as would be appreciated), matching again preferably occurs at the product level due to a reduced number of key measurements relative to a greater number of body measurements as mentioned above. K-means clustering receives customer body measurements 450, host body measurements 410, and sizing guides 420 and divides these collective measurements into a set of non-overlapping clusters. If a particular customer 350 and a particular host 310 are grouped in the same cluster, then such particular customer 350 and such particular host 310 are labeled (or otherwise identified) as a match.

Generally speaking, K-means clustering determines K different averages or centroids of points in a given data set and assigns each point in the data set to one of these centroids based on numerical distances (e.g., Euclidean, Manhattan, Cosine, etc.) between each point and the respective given centroid. The centroid of a given cluster is iteratively recalculated based on the points in the cluster until the centroid values do not change. Pseudocode for this technique is:
1. Select K points as the initial centroids
2. Calculate the distance between every data point and the K initial centroids
3. Assign the data points to their closest centroids
4. Recalculate the centroids for each new cluster
5. Repeat operations 2, 3, and 4 until the values of centroids don't change
   In some implementations of the invention, sizing guides 420 may be used as the initial centroids, which often causes the final clusters to represent the different sizes available for the clothing item. However, as described above, the size corresponding to a given cluster may not be the size recommended to customer 350 by host 310 after host 310 tries on clothing item 320.

For example, Table 1 is a sizing chart for tops offered by Brand A for male customers. Table 2 is a corresponding sizing chart for Brand B. As evident from these tables, the brands have different fit models because their size measurement ranges (specifically, upper bounds of the measurement ranges) for both chest and waist are different.

TABLE 1
Brand A Sizing Chart for Men's Tops

| Size | Chest (cm) | Waist (cm) |
|---|---|---|
| XS | 83.82 | 73.66 |
| S | 93.98 | 81.28 |
| M | 101.6 | 88.9 |
| L | 5.76 | 99.06 |
| XL | 121.92 | 109.22 |
| XXL | 132.08 | 119.38 |

TABLE 2
Brand B Sizing Chart for Men's Tops

| Size | Chest (cm) | Waist (cm) |
|---|---|---|
| XS | 81 | 70 |
| S | 92 | 76 |
| M | 102 | 85 |
| L | 112 | 94 |
| XL | 122 | 104 |
| XXL | 132 | 116 |

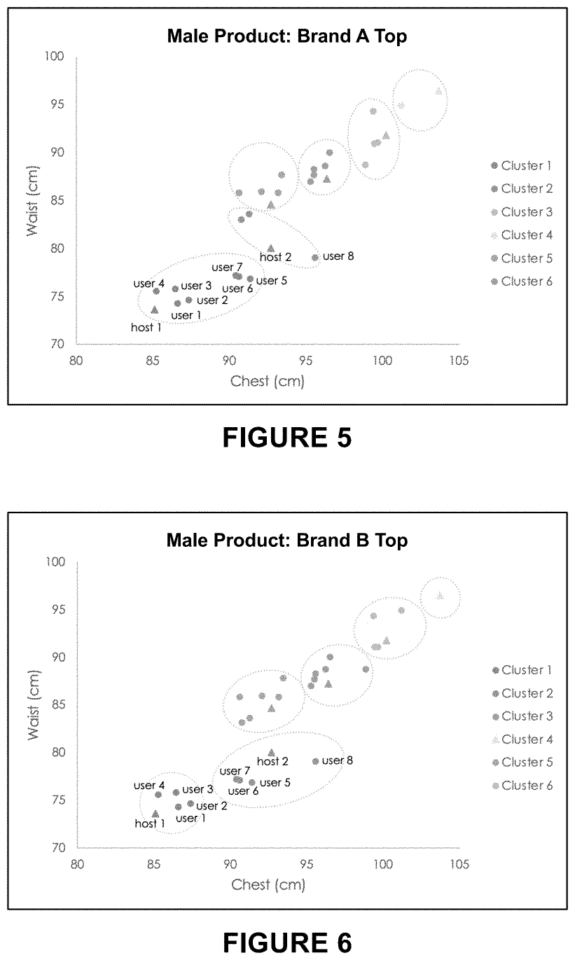

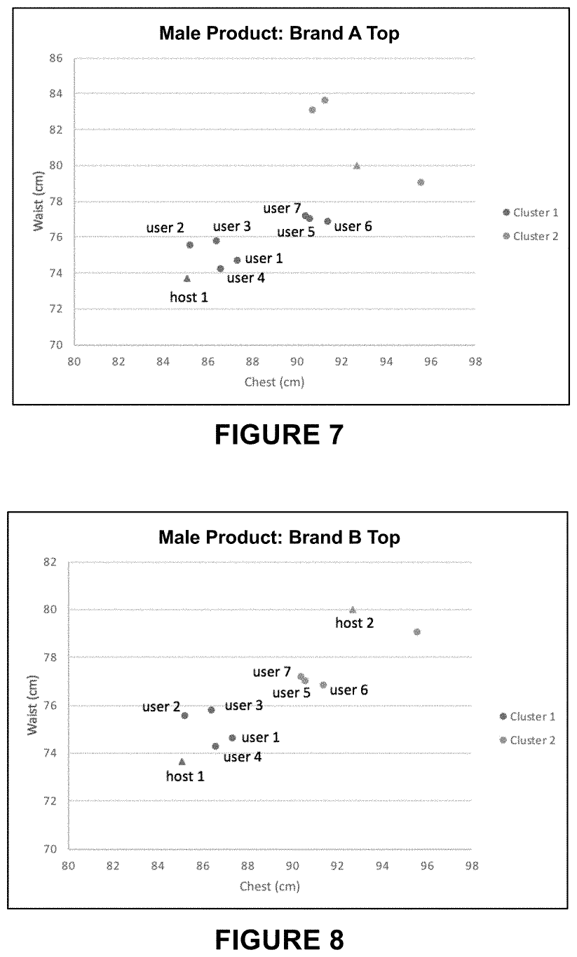

FIG. 5 illustrates clusters of hosts 310 and customers 350 (referred to as “users” in FIG. 5) for Brand A, and FIG. 6 illustrates clusters of hosts 310 and customers 350 (referred to as “users” in FIG. 6) for Brand B; in both cases, triangles represent hosts 310 and circles represent customers 350. FIGS. 5 and 6 demonstrate that not all customers 350 are matched with the same host 310 across different brands. FIG. 7 illustrates cluster 1 and cluster 2 using sizing chart for Brand A. As illustrated, Host 1 is matched with Users 1-7. However, when sizing chart for Brand B is used, Users 5, 6, and 7 are matched to Host 2 instead of Host 1, as illustrated in FIG. 8. This behavior is expected because the brands have different upper bounds for each size, meaning that while Users 5, 6 and 7 fall in the XS size for Brand A, they fall in the S size for Brand B. Once again, these customers 350 should not necessarily purchase the XS size for Brand A; instead, host 310 within their cluster will determine, and subsequently recommend, which size for Brand A should actually fit them best.

As would be appreciated, K-means clustering may be sensitive to outliers, which means that customers 350 with very different customer body measurements 450 from those of other customers 350 may skew the final clusters, thereby reducing quality of matches. As would also be appreciated, K-means clustering is most suitable when the variance of each attribute is similar, leading to circular-shaped clusters; however, because body measurements vary from measurement type to measurement type, K-means clustering may have a hard time deciding which data points belong to a given cluster. As would also be appreciated, body measurements may be normalized to account for different scales associated with different types of body measurements.

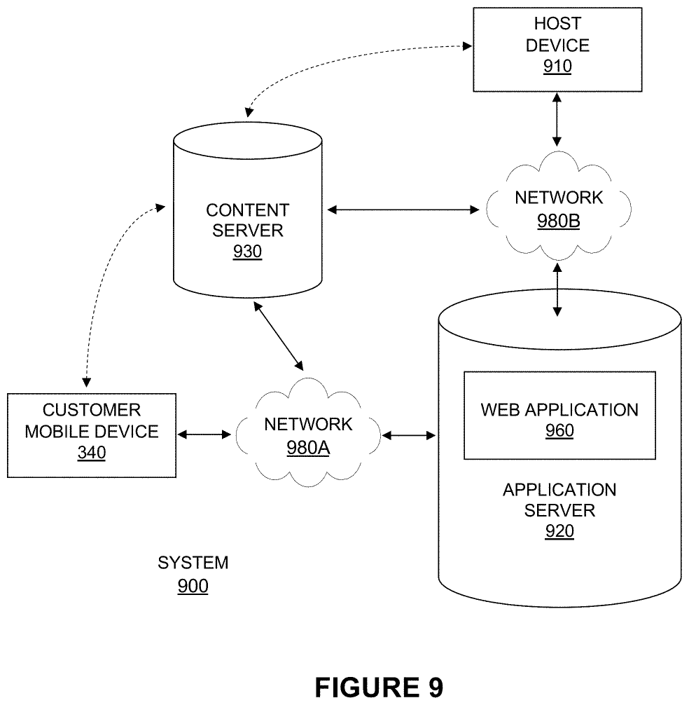

FIG. 9 illustrates a system 900 for providing content, including, but not limited to, video stream 330, about clothing item 320 to customers 350 in accordance with various implementations of the invention. System 900 includes an application server 920 on which operates a web application 960 as would be appreciated. According to various implementations of the invention, web application 960, when operating on application server 920, provides various functionality described herein as would be appreciated. Web application 960 is coupled to one or more customer devices, including, but not limited to customer mobile devices 340, via various networks (e.g., a network 980A) as would be appreciated. Customer mobile devices 340 provide functionality for customers 350 to interact with web application 960 as would be appreciated. Web application 960 is coupled to one or more host devices 910 (which may include mobile devices) via various networks (e.g., a network 980B) as would be appreciated. Host devices 910 provide functionality for host 310 to interact with web application 960 as would be appreciated. In some implementations, system 900 includes a content server 930, which may be a standalone content server or may reside with web application 960 on application server 920 as would be appreciated. Hosts 310, via host device 910, may upload content to content server 930, which content may be subsequently provided to customers 350 via customer mobile device 340 as directed by web application 960 in accordance with various implementations of the invention as would be appreciated.

While the invention has been described herein in terms of various implementations, it is not so limited and is limited only by the scope of the following claims, as would be apparent to one skilled in the art. These and other implementations of the invention will become apparent upon consideration of the disclosure provided above and the accompanying figures. In addition, various components and features described with respect to one implementation of the invention may be used in other implementations as well.

What is claimed is:

1. A method for providing content to a customer, the method comprising:
receiving a plurality of customer body measurements from the customer;
receiving a plurality of host body measurements from each of a plurality of hosts;
matching the customer with one of the plurality of hosts based on at least some of the plurality of customer body measurements and at least some of the plurality of host body measurements from each of the plurality of hosts;
providing, to the customer, content or a link to content that includes the matched one of the plurality of hosts curating a clothing item available for purchase by the customer.

2. The method of claim 1, further comprising receiving a sizing guide associated with the clothing item available for purchase, the sizing guide comprising a plurality of measurements or measurement ranges for the clothing item, and wherein matching the customer with one of the plurality of hosts comprises matching the customer with one of the plurality of hosts based on at least some of the plurality of customer body measurements, at least some of the plurality of host body measurements from each of the plurality of hosts, and the sizing guide.

3. The method of claim 1, further comprising receiving actual dimensions of the clothing item available for purchase, and wherein matching the customer with one of the plurality of hosts comprises matching the customer with one of the plurality of hosts based on at least some of the plurality of customer body measurements, at least some of the plurality of host body measurements from each of the plurality of hosts, and the actual dimensions.

4. The method of claim 1, wherein matching the customer with one of the plurality of hosts comprises matching the customer with one of the plurality of hosts based on at least some of the plurality of customer body measurements, at least some of the plurality of host body measurements from each of the plurality of hosts, and key measurements associated with the clothing item.

5. The method of claim 1, wherein matching the customer with one of the plurality of hosts comprises matching the customer with one of the plurality of hosts based on at least some of the plurality of customer body measurements, at least some of the plurality of host body measurements from each of the plurality of hosts, key measurements associated with the clothing item, and additional body measurements deemed important by the host.

6. The method of claim 1, wherein providing, to the customer, content or a link to content comprises providing an image that depicts the matched one of the plurality of hosts wearing the clothing item.

7. The method of claim 1, wherein providing, to the customer, content or a link to content comprises providing a video stream that depicts the matched one of the plurality of hosts wearing the clothing item.

8. The method of claim 1, wherein the content comprises the matched one of the plurality of hosts describing or evaluating the clothing item or its fit.

9. The method of claim 1, wherein the clothing item comprises an apparel clothing item, a footwear clothing item, or an accessory clothing item.

10. The method of claim 1, further comprising receiving an order, from the customer, for a purchase of the clothing item.

11. The method of claim 1, further comprising providing the customer with information that compares the customer body measurements to the host body measurements.

12. The method of claim 1, further comprising providing the customer with a direct purchasing option to purchase the clothing item.

13. The method of claim 1, further comprising providing the customer with an indirect purchasing option to purchase the clothing item.

14. A method for providing content regarding an item to a customer, the method comprising:
receiving a plurality of customer factors of the customer, wherein the plurality of customer factors are relevant to the item and characteristic of the customer;
receiving a plurality of host factors of each of a plurality of hosts, wherein the plurality of host factors are relevant to the item and characteristic of the respective host;
matching the customer with one of the plurality of hosts based on at least some of the plurality of customer factors and at least some of the plurality of host factors from each of the plurality of hosts;
providing, to the customer, content or a link to content that includes the matched one of the plurality of hosts curating the item available for purchase by the customer.

15. The method of claim 14, wherein the item is a beauty item.

16. The method of claim 15, wherein the plurality of host factors comprises an eye color of the host, a hair color of the host, a skin tone of the host, a skin color of the host, a skin complexion of the host, or a skin condition of the host and wherein the plurality of customer factors comprises an eye color of the customer, a hair color of the customer, a skin tone of the customer, a skin color of the customer, a skin complexion of the customer, or a skin condition of the customer.

17. The method of claim 14, wherein the item is a clothing item.
